(19) United States
(12) Patent Application Publication
(10) Pub. No.: US 2025/0124385 A1
(43) Pub. Date: Apr. 17, 2025

(54) STRATEGY PLANNING SUPPORT APPARATUS, STRATEGY PLANNING SUPPORT METHOD, AND PROGRAM

(71) Applicant: NIPPON TELEGRAPH AND TELEPHONE CORPORATION, Tokyo (JP)

(72) Inventors: Machiko SHINOZUKA, Tokyo (JP); Xiaoxi ZHANG, Tokyo (JP); Masahiro SOTOMA, Tokyo (JP); Minako HARA, Tokyo (JP)

(21) Appl. No.: 18/683,632

(22) PCT Filed: Sep. 17, 2021
(86) PCT No.: PCT/JP2021/034347

§ 371 Date: Feb. 14, 2024

(51) Int. Cl. G06Q 10/0637; G06F 16/334

(52) U.S. Cl. CPC G06Q 10/0637; G06F 16/3347

(57) ABSTRACT

An object of the present invention is to propose a technique that enables even a person who is not an expert to easily identify a DF in order to support creation of a scenario in accordance with an actual situation of an organization such as a company.

According to the present invention, there is provided a strategic planning support device 3 that supports strategic planning of a company, the device 3 including: a relationship analysis unit 34 configured to analyze a word representing human behavior or regulations related to each of a plurality of detailed items in a financial index of a predetermined organization, the financial index varying due to a past similar event similar to an event of the predetermined organization; and an output unit 35 configured to output, as each element of a coordinate axis of a driving force, a first word representing human behavior related to a first detailed item having the largest ratio in the financial index and a second word representing human behavior related to a second detailed item in which an absolute value of a correlation coefficient related to a correlation with the human behavior or regulations related to the first detailed item is equal to or less than a threshold value, among the plurality of detailed items.

### TECHNICAL FIELD

The content of present disclosure relates to a strategic planning support device, a strategic planning support method, and a program.

### BACKGROUND ART

Many uncertain events (hereinafter indicated as “event”) that can affect people's lives and company activities such as infectious diseases and climate change have been identified. For the purpose of planning a policy and a strategy for responding to such an event, the influence of the event is analyzed by creating possible scenarios. In particular, companies are required to analyze the influence of events on their business and disclose information as risks and opportunities, and use this as a basis for planning management strategies.

In the creation of a scenario for planning a strategy of a company, it is common to investigate elements related to an analysis target, set two axes (DF: driving force) that can greatly influence the future, and draw a plurality of scenarios along the DF (refer to Non Patent Literature 1).

FIG. 11 is a conceptual diagram of scenario creation by general scenario planning. As illustrated in FIG. 11, “diversity” is set as an element of the X axis, the diversity increases going in the + direction, and the uniformity increases going in the − direction. In addition, “linking with regions” is set as an element of the Y axis, the linking with regions becomes stronger going in the + direction, and the linking with regions becomes weaker going in the − direction. In order to effectively utilize the scenario, it is important what each element (word) of the coordinate axes of the DF is set to.

Conventionally, experts in this field have manually determined a DF based on experience or the like (refer to Non Patent Literature 2). In this example, in order to examine how a sustainable society should be from the viewpoint of lifestyle, a workshop is held by experts, the experts select DFs, and scenarios regarding a plurality of lifestyles are drawn.

### CITATION LIST

### Non Patent Literature

Non Patent Literature 1: Seiji Hashimoto, “Junkangata shakai vision kentou no tame no scenario planning (in Japanese) (Scenario Planning for Consideration of Circulatory Social Vision)”, National Institute for Environmental Studies News, Vol. 28, No. 2, published in June 2009, p. 3-5 <https://www.nies.go.jp/kanko/news/28/28-2/28-2-02.html>
Non Patent Literature 2: Kimura et al., “Scenario writing shuhou wo mochita jizokukanou na lifestyle no sakusei to kankyoufuka no hyouka (in Japanese) (Creation of a Sustainable Lifestyle and Evaluation of Environmental Burden Using a Scenario Writing Method)”, Papers on Environmental Information Science 21, pp. 261-266, 2007

### SUMMARY OF INVENTION

### Technical Problem

However, in the conventional scenario creation, there is a problem that expertise is required for selection of the DF and time is required for information analysis. Furthermore, in order to apply the scenario creation method to the strategic planning of an organization such as a company, there is also a problem that it is required to reflect the situation of the company in addition to the knowledge regarding the analysis target.

The present invention has been made in view of the above points, and an object of the present invention is to propose a technique that enables even a person who is not an expert to easily identify a DF in order to support creation of a scenario of strategic planning of a company in accordance with an actual situation of the company.

### Solution to Problem

In order to solve the above problem, the present invention according to claim 1 provides a strategic planning support device that supports strategic planning of an organization, the device including: relationship analysis means configured to analyze a word representing human behavior or regulations related to each of a plurality of detailed items in a financial index of a predetermined organization, the financial index varying due to a past similar event similar to an event of the predetermined organization; and output means configured to output, as each element of a coordinate axis of a driving force, a first word representing human behavior related to a first detailed item having the largest ratio in the financial index and a second word representing human behavior related to a second detailed item in which an absolute value of a correlation coefficient related to a correlation with the human behavior or regulations related to the first detailed item is equal to or less than a threshold value, among the plurality of detailed items.

### Advantageous Effects of Invention

As described above, according to the present invention, there is an effect that even a person who is not an expert can easily identify a DF in order to support creation of a scenario of strategic planning of a company according to an actual situation of the company.

### BRIEF DESCRIPTION OF DRAWINGS

FIG. 1 is a schematic diagram of a communication system.

FIG. 2 is an electrical hardware configuration diagram of a strategic planning support device.

FIG. 3 is an electrical hardware configuration diagram of a communication terminal.

FIG. 4 is a functional configuration diagram of a strategic planning support device.

FIG. 5 is a flowchart illustrating processing of setting a driving force in a case of creating a scenario that can occur in the future for planning a strategy of a company.

FIG. 6 is a flowchart illustrating processing of setting a driving force in a case of creating a scenario that can occur in the future for planning a strategy of a company.

FIG. 7 is a graph showing changes in transportation revenue of a railway company which is another company in the same industry as that of a company which is an analysis target.

FIG. 8 is a diagram illustrating a ratio of transportation revenue as a detailed item in a financial index of a company which is an analysis target.

FIG. 9 is a diagram showing detailed items in a financial index of a company which is an analysis target and words representing human behavior corresponding to the detailed items.

FIG. 10 is a conceptual diagram of scenario creation by scenario planning according to the present embodiment.

FIG. 11 is a conceptual diagram of scenario creation by general scenario planning.

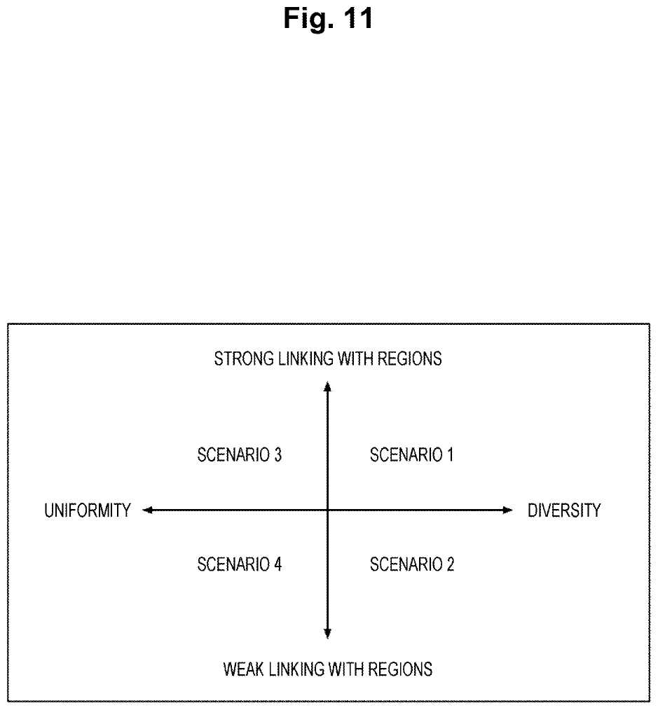

### DESCRIPTION OF EMBODIMENTS

Hereinafter, an embodiment of the present invention will be described with reference to the drawings.

### System Configuration of Embodiment

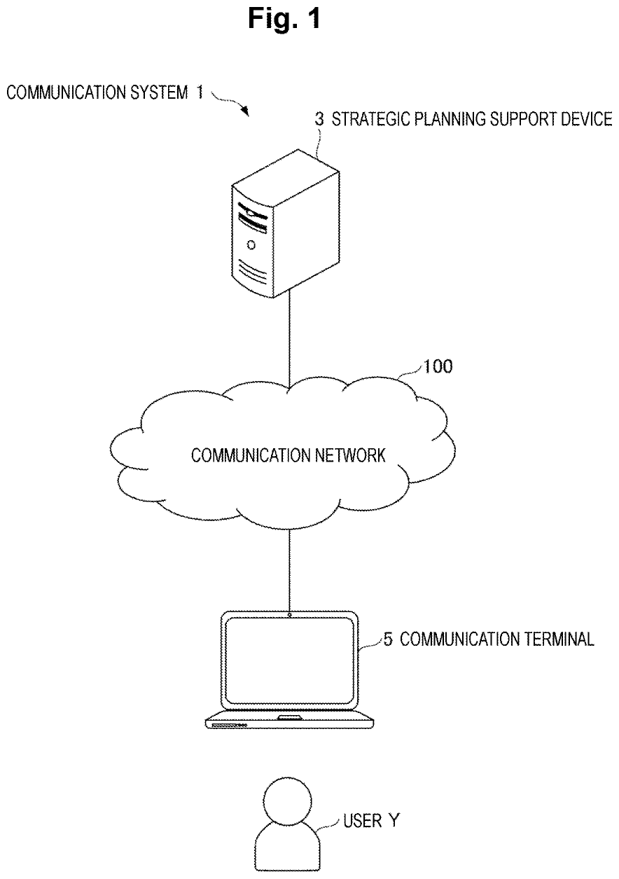

First, an outline of a configuration of a communication system of the present embodiment will be described with reference to FIG. 1. FIG. 1 is a schematic diagram of the communication system according to the embodiment of the present invention.

As illustrated in FIG. 1, a communication system 1 of the present embodiment is constructed by a strategic planning support device 3 and a communication terminal 5. The communication terminal 5 is managed and used by a user Y.

The strategic planning support device 3 and the communication terminal 5 can communicate with each other via a communication network 100 such as the Internet. The connection form of the communication network 100 may be either wireless or wired.

The strategic planning support device 3 includes one or a plurality of computers. In a case where the strategic planning support device 3 includes a plurality of computers, the strategic planning support device 3 may be referred to as a “strategic planning support device” or a “strategic planning support system”.

The strategic planning support device 3 is a device that supports strategic planning of a company by setting a driving force (DF) used for creating a scenario of strategic planning of an organization such as a company. The organization includes, for example, an incorporated association, a non-profit organization (NPO), a non-governmental organization (NGO), and the like, in addition to a company.

The communication terminal 5 is a computer, and FIG. 1 illustrates a laptop personal computer as an example. In FIG. 1, the user Y operates the communication terminal 5. Note that the processing may be performed by the strategic planning support device 3 alone without using the communication terminal 5.

### [Hardware Configuration]

### <Hardware Configuration of Strategic Planning Support Device>

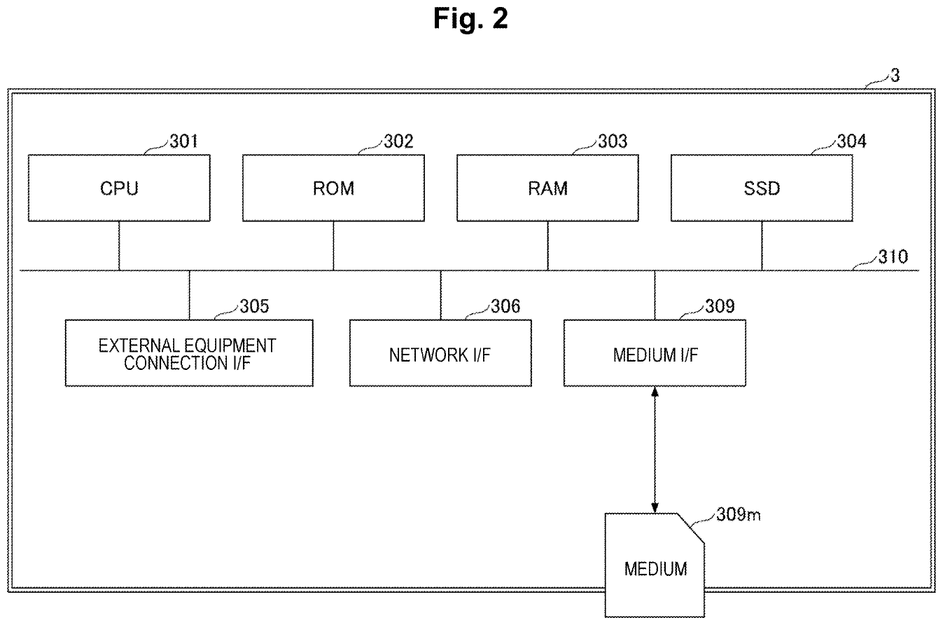

Next, FIG. 2 describes an electrical hardware configuration of the strategic planning support device 3. FIG. 2 is an electrical hardware configuration diagram of a strategic planning support device.

As illustrated in FIG. 2, the strategic planning support device 3 includes, as a computer, a central processing unit (CPU) 301, a read only memory (ROM) 302, a random access memory (RAM) 303, a solid state drive (SSD) 304, an external equipment connection interface (I/F) 305, a network I/F 306, a medium I/F 309, and a bus line 310.

Among them, the CPU 301 controls the operation of the entire strategic planning support device 3. The ROM 302 stores a program used for driving the CPU 301, such as an initial program loader (IPL). The RAM 303 is used as a work area of the CPU 301.

The SSD 304 reads or writes various data under the control of the CPU 301. Note that a hard disk drive (HDD) may be used instead of the SSD 304.

The external equipment connection I/F 305 is an interface for connecting various types of external equipment. Examples of the external equipment in this case include a display, a speaker, a keyboard, a mouse, a universal serial bus (USB) memory, and a printer.

The network I/F 306 is an interface for performing data communication via the communication network 100.

The medium I/F 309 controls reading or writing (storing) of data with respect to a recording medium 309m such as a flash memory. Examples of the recording medium 309m also include a digital versatile disc (DVD), a Blu-ray Disc (registered trademark), and the like.

The bus line 310 is an address bus, a data bus, or the like for electrically connecting the respective components such as the CPU 301 illustrated in FIG. 2.

### <Hardware Configuration of Communication Terminal>

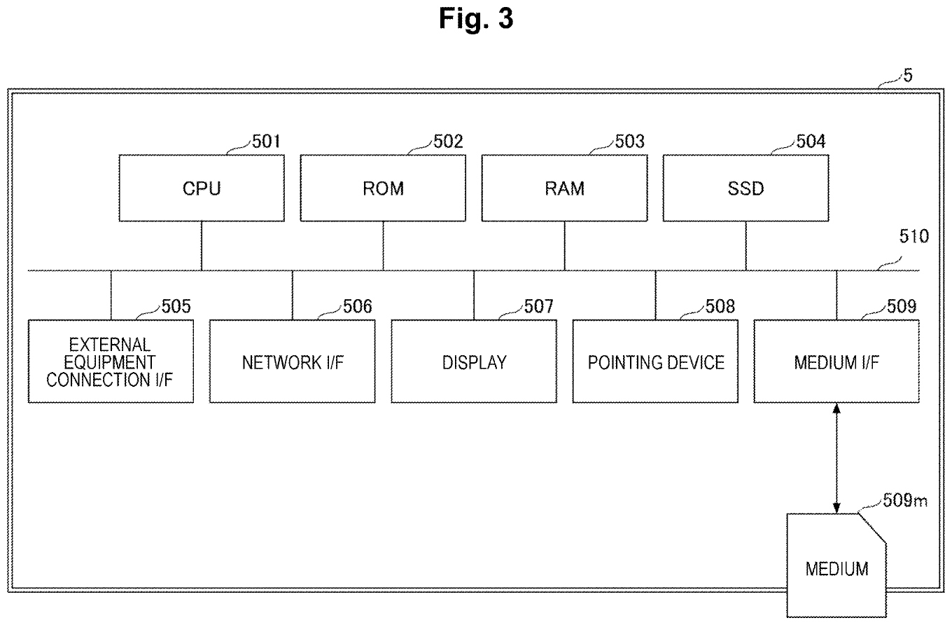

Next, an electrical hardware configuration of the communication terminal 5 will be described with reference to FIG. 3. FIG. 3 is an electrical hardware configuration diagram of the communication terminal.

As illustrated in FIG. 3, the communication terminal 5 includes, as a computer, a CPU 501, a ROM 502, a RAM 503, an SSD 504, an external equipment connection interface (I/F) 505, a network I/F 506, a display 507, a pointing device 508, a medium I/F 509, and a bus line 510.

Among them, the CPU 501 controls the operation of the entire communication terminal 5. The ROM 502 stores a program used for driving the CPU 501 such as IPL. The RAM 503 is used as a work area of the CPU 501.

The SSD 504 reads or writes various types of data under the control of the CPU 501. Note that a hard disk drive (HDD) may be used instead of the SSD 504.

The external equipment connection I/F 505 is an interface for connecting various types of external equipment. Examples of the external equipment in this case include a display, a speaker, a keyboard, a mouse, a USB memory, and a printer.

The network I/F 506 is an interface for performing data communication via the communication network 100.

The display 507 is a type of display means such as liquid crystal or organic electro luminescence (EL) that displays various images.

The pointing device 508 is a type of input means that performs selection and execution of various instructions, selection of a processing target, movement of a cursor, and the like. Note that, in a case where the user Y uses a keyboard, the function of the pointing device 508 may be turned off.

The medium I/F 509 controls reading or writing (storing) of data with respect to a recording medium 509m such as a flash memory. The recording medium 509m also includes a DVD, a Blu-ray Disc (registered trademark), and the like.

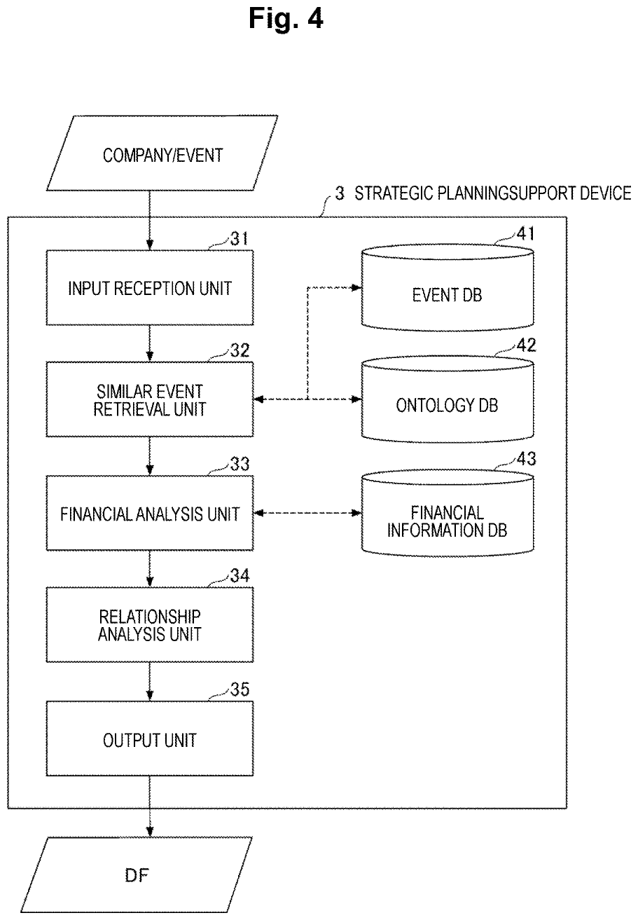

The bus line 510 is an address bus, a data bus, or the like for electrically connecting each component such as the CPU 501 illustrated in FIG. 4.

### [Functional Configuration of Strategic Planning Support Device]

Next, a functional configuration of the strategic planning support device will be described with reference to FIG. 4. FIG. 4 is a functional configuration diagram of the strategic planning support device according to the embodiment of the present invention.

In FIG. 4, the strategic planning support device 3 includes an input reception unit 31, a similar event retrieval unit 32, a financial analysis unit 33, a relationship analysis unit 34, and an output unit 35. Each of these units is a function realized by a command by the CPU 301 in FIG. 2 based on a program.

Further, an event database (DB) 41, an ontology DB 42, and a financial information DB 43 are constructed in the RAM 303 or the HD 304 of FIG. 2.

### <Description of DB>

### (Event DB)

The event DB 41 stores data indicating past events. The data indicating the past event includes an occurrence time (or date and time), an event name, and an event content.

### (Ontology DB)

In the ontology DB 42, data indicating a dictionary in which a relationship between things is structured is stored as ontology data.

### (Financial Information DB)

In the financial information DB, financial information of each company such as a company which is an analysis target and other companies in the same industry as this company is stored. The financial information includes, for example, information such as a securities report including financial statements and the like. Note that the other company in the same industry is an example of the other organization of the same type as that of an organization such as a company.

### <Each Functional Configuration>

Next, each functional configuration of the strategic planning support device will be described with reference to FIGS. 2 to 4.

The input reception unit 31 receives, from the user Y via the communication terminal 5 and the network I/F 306, the input of a company name of a company which is an analysis target and each piece of data of events of the company. Note that input of each piece of the above data may be received from the outside via the external equipment connection I/F 305 or the medium I/F 309 in FIG. 2.

The similar event retrieval unit 32 uses the data indicating the company name and the event received by the input reception unit 31 as a retrieval key, and retrieves past similar events using the event DB 41 and the ontology DB 42.

The financial analysis unit 33 refers to the financial statements in the securities reports of the company which is an analysis target or another company in the same industry managed in the financial information DB 43 in a predetermined period (for example, approximately two years) before and after the time when the past similar event occurred, identifies the financial index varying due to the past similar event, and analyzes the breakdown of the financial index in the company which is an analysis target.

The relationship analysis unit 34 analyzes words representing human behavior (or regulations) related to each of a plurality of detailed items in the financial index of the company which is an analysis target (that is, having an influence). In addition, the relationship analysis unit 34 analyzes a correlation between human behavior (or regulations) related to a detailed item having the largest ratio and human behavior (or regulations) related to a detailed item having an i-th largest ratio (initial value: i=2). Furthermore, the relationship analysis unit 34 determines whether the absolute value of the correlation coefficient related to the analyzed correlation is equal to or less than a threshold value.

The output unit 35 outputs data of a word representing human behavior (or regulations) related to the detailed item having the largest ratio and a word representing human behavior (or regulations) related to the detailed item having the correlation coefficient equal to or less than the threshold value as two DEs. Examples of the output method include transmitting, displaying, or printing word data as a DF to the communication terminal 5.

### Processing or Operation of Embodiment

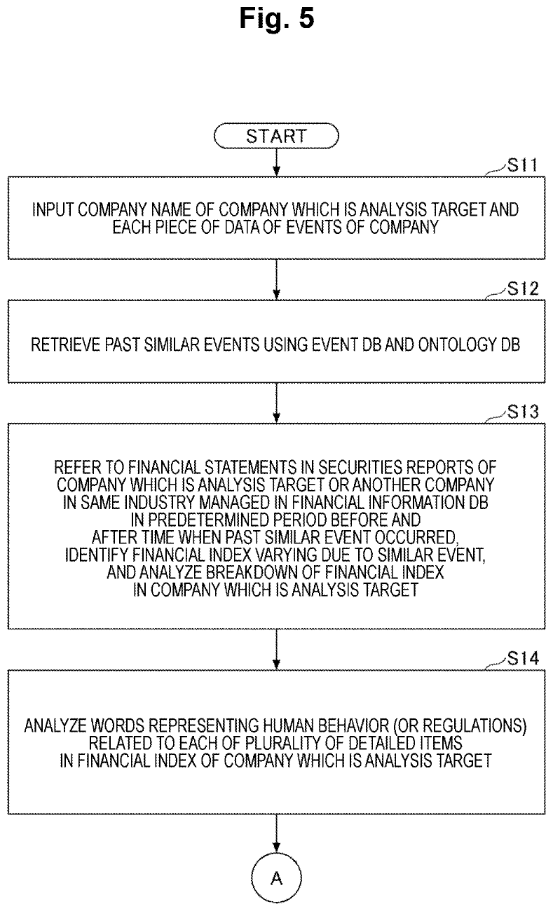

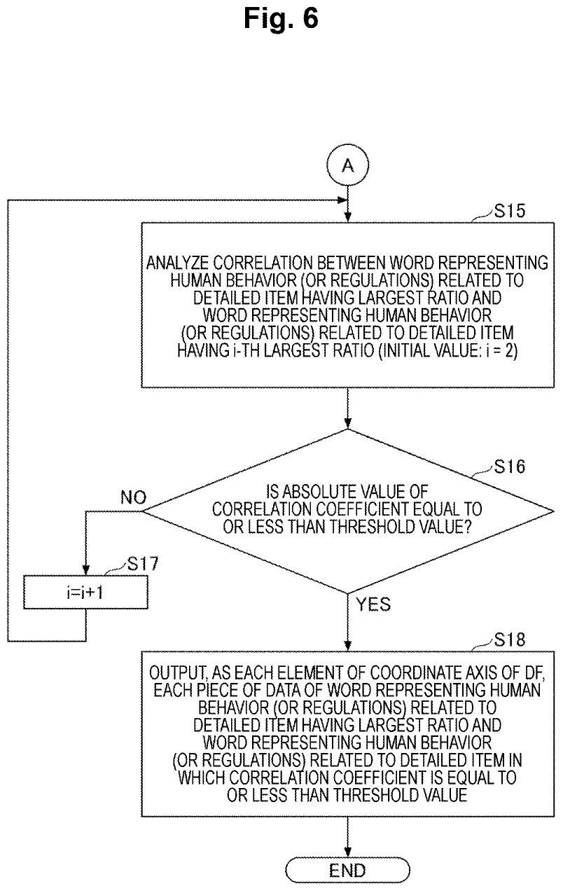

Next, processing or operation of the present embodiment will be described in detail with reference to FIGS. 5 to 10. FIGS. 5 and 6 are flowcharts illustrating processing of setting a driving force in a case of creating a scenario that can occur in the future for planning a strategy of a company.

As illustrated in FIG. 5, first, the input reception unit 31 receives, from the user Y via the communication terminal 5, the input of a company name of a company which is an analysis target and each piece of data of events of the company (S11). Note that input of data of a company name is not necessarily required. In addition, the user Y may directly input data to the strategic planning support device 3 without using the communication terminal 5.

Next, the similar event retrieval unit 32 uses at least event data among the company name and the event received in step S11 as a retrieval key, and retrieves past similar events using the event DB 41 and the ontology DB 42 (S12). Specifically, the similar event retrieval unit 32 extracts all the events that occurred in the past using the event DB 41, and further retrieves a past similar event similar to the event input in step S11 using the ontology dictionary stored in the ontology DB 42.

For example, the similar event retrieval unit 32 uses the event DB 41 and the ontology DB 42 to retrieve H1N1 influenza as an infectious disease having occurred in the past, as a past similar event to the COVID-19 that is a current event.

Next, the financial analysis unit 33 refers to the financial statements in the securities reports of the company which is an analysis target or another company in the same industry managed in the financial information DB 43 in a predetermined period (for example, approximately two years) before and after the time when the past similar event occurred, identifies the financial index of a predetermined sector of a company that is an analysis target, the financial index varying due to the past similar event, and analyzes the breakdown of the financial index (S13). Note that the financial index here is an index of granularity similar to that of the segment, such as revenue of the transportation sector (business) as a predetermined sector.

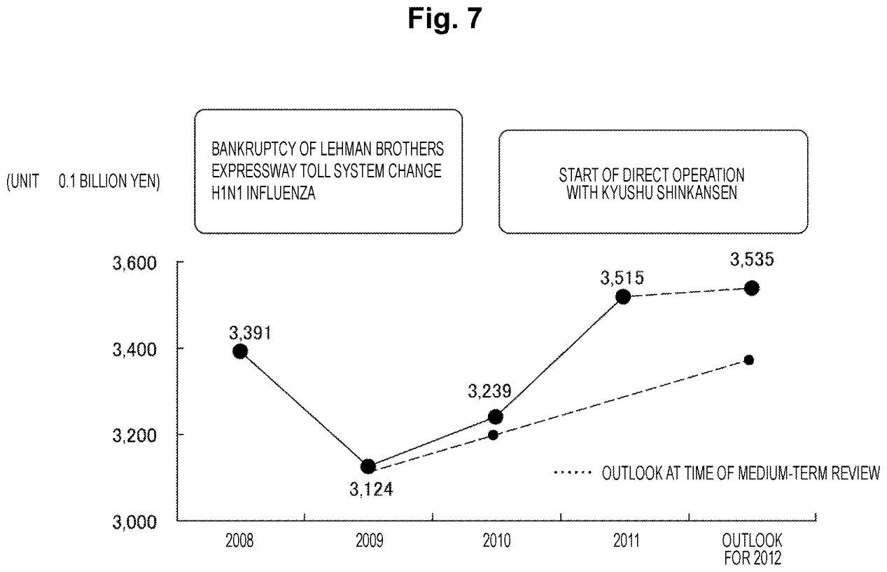

FIG. 7 is a graph showing changes in transportation revenue of a railway company which is another company in the same industry as that of the company which is an analysis target. For example, the financial analysis unit 33 uses the financial statement DB 43 to refer to changes in financial indexes before and after H1N1 influenza epidemic in railway companies including other companies. As shown in FIG. 7, in a certain other railway company, transportation revenue decreases in 2009, and an epidemic of H1N1 influenza is cited as a cause.

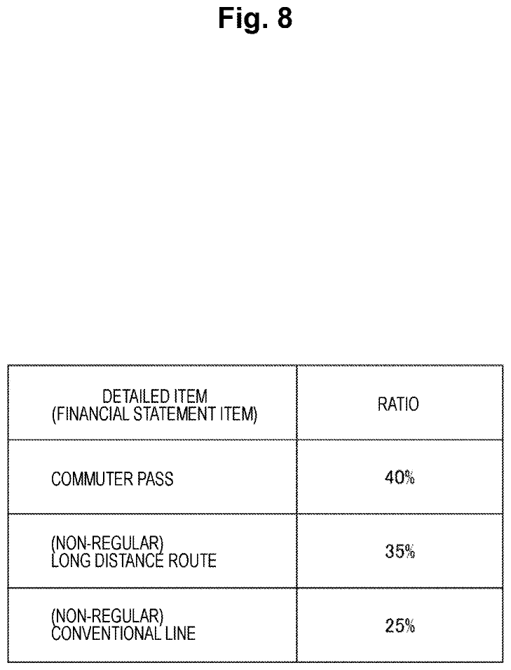

FIG. 8 is a diagram illustrating a ratio of transportation revenue as a detailed item in a financial index of a company which is an analysis target. Here, it is illustrated that, among the detailed items (here, a financial statement item) constituting the transportation revenue, the ratio of the revenue from the sale of the commuter pass is 40%, the ratio of the revenue from the sale of the ticket for the (non-regular) long distance route is 35%, and the ratio of the revenue from the sale of the ticket for the (non-regular) conventional line is 25%.

Next, the relationship analysis unit 34 analyzes words representing human behavior (or regulations) related to each of a plurality of detailed items in the financial index of the company which is an analysis target (that is, having an influence) (S14). Specifically, the relationship analysis unit 34 analyzes a word having a similarity close to each of the detailed items and representing human behavior (or regulations) by natural language processing of vectorizing the word or the like.

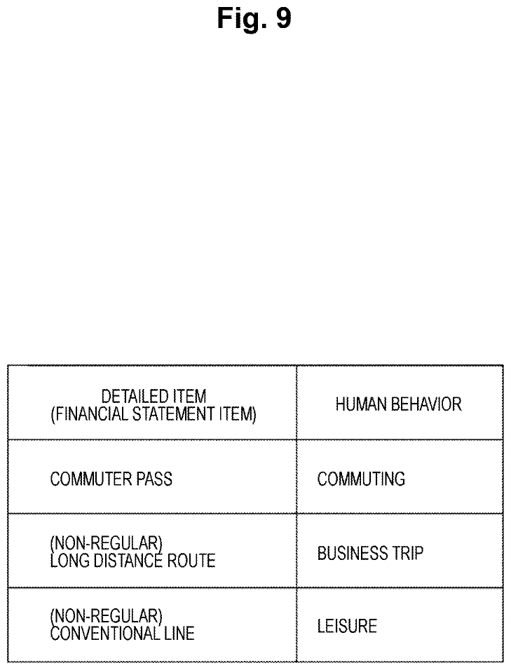

FIG. 9 is a table showing detailed items in a financial index of a company which is an analysis target and human behavior corresponding to the detailed items. Here, among the detailed items constituting the transportation revenue, the word representing the human behavior for the sale of the commuter pass is identified as “commuting”, the word representing the human behavior for the sale of the ticket for the (non-regular) long distance route is identified as “business trip”, and the word representing the human behavior for the sale of the ticket for the (non-regular) conventional line is identified as “leisure”.

Next, returning to FIG. 6, the relationship analysis unit 34 analyzes a correlation between human behavior (or regulations) related to a detailed item having the largest ratio and human behavior (or regulations) related to a detailed item having an i-th largest ratio (initial value: i=2) (S15).

Next, the relationship analysis unit 34 determines whether the absolute value of the correlation coefficient related to the correlation analyzed in step S15 is equal to or less than a threshold value (S16). When the absolute value of the correlation coefficient is not equal to or less than the threshold value (that is, in the case of less than the threshold value), (S16; NO), “i=i+1” (S17), and the processing returns to step S15 again and continues. On the other hand, when the absolute value of the correlation coefficient is equal to or less than the threshold value in step S16 above (step S16; YES), the output unit 35 outputs, as each element of the coordinate axis of the DF, each piece of data of the word representing human behavior (or regulations) related to the first detailed item having the largest ratio and the word representing human behavior (or regulations) related to the detailed item in which the correlation coefficient is equal to or less than the threshold value (S18).

Here, an example of steps S15 to S18 will be described.

First, in step S15, the relationship analysis unit 34 identifies “commuting” as a word representing human behavior related to the detailed item (here, a “commuter pass”) with the largest ratio (here, 40%) in FIGS. 8 and 9. Accordingly, the word “commuting” is selected as one of the two DFs. Furthermore, in step S15, the relationship analysis unit 34 identifies “business trip” as a word representing human behavior related to the detailed item (here, a “(non-regular) long distance route”) having the second largest ratio (here, 35%) in FIGS. 8 and 9. Then, in step S15, as a result of analyzing the correlation between the word “commuting” and the word “business trip”, the relationship analysis unit 34 has found that the numerical value (for example, cosine similarity) representing the correlation coefficient is “0.7”. Since the numerical value is equal to or greater than the threshold value (here, “0.5”) in step S16, the process proceeds to step S17 and returns to step S15 again.

Next, in step S15 again, the relationship analysis unit 34 identifies “leisure” as a word representing human behavior related to the detailed item (here, a “(non-regular) conventional route”) having the third largest ratio (here, 25%) in FIGS. 8 and 9. Then, in step S15, as a result of analyzing the correlation between the word “commuting” and the word “leisure”, the relationship analysis unit 34 has found that the correlation coefficient is “0.2”. Therefore, since the numerical value is equal to or greater than the threshold value (here, “0.5”) in step S16, the process proceeds to step S18. Then, in step S18, the output unit 35 outputs each data of the word “commuting” and the word “leisure” as an element of each coordinate axis of the DF.

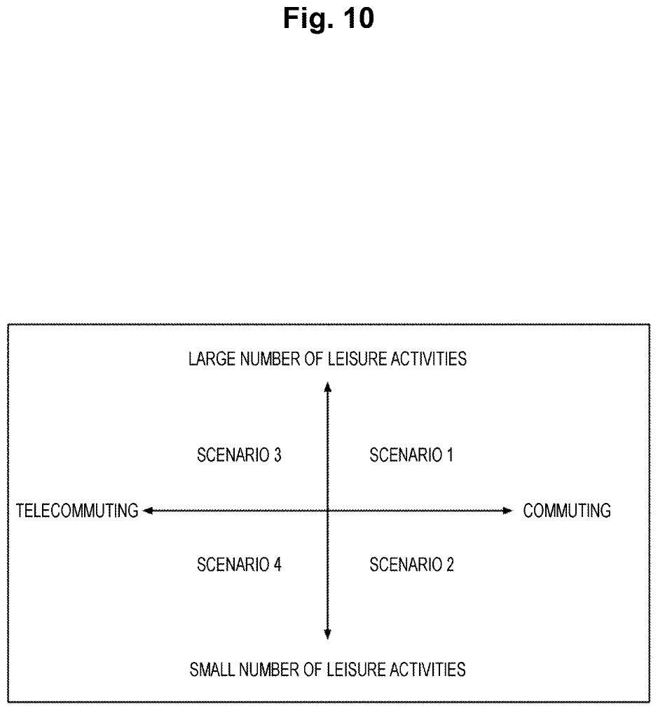

As described above, as illustrated in FIG. 10, in the scenario creation by scenario planning, “commuting” is set as an element of the X axis, the number of commutes increases going in the + direction, and the telecommuting increases going in the − direction. Furthermore, “leisure” is set as an element of the Y axis, the number of leisure activities increases going in the + direction, and the number of leisure activities decreases going in the − direction. As described above, in the scenario creation by scenario planning, “telecommuting” to be compared in social life is set for “commuting”, or a phrase “the number of leisure activities is small” that is opposite to “the number of leisure activities is large” is set.

### Effects of Embodiment

As described above, according to the present embodiment, there is an effect that even a person who is not an expert can easily identify a DF in order to support creation of a scenario according to an actual situation of the company.

### [Supplement]

The present invention is not limited to the above-described embodiment, and may be configured or processed (operated) as described below.

(1) Although the strategic planning support device 3 can be realized by a computer and a program, the program can also be recorded in a recording medium or provided via a communication network 100.

(2) In communication between the strategic planning support device 3 and the communication terminal 5, another device (server, router, and the like) may relay data. For example, in the present specification, for the sake of simplicity, it is described that the input reception unit 31 of the strategic planning support device 3 transmits the data to the communication terminal 5, but this transmission processing includes a case where another device relays the data.

(4) In the above embodiment, a laptop personal computer is shown as an example of the communication terminal 5, but the communication terminal 5 is not limited to this, and may be, for example, a desktop personal computer, a tablet terminal, a smartphone, a smartwatch, a car navigation device, a refrigerator, a microwave oven, or the like.

(5) Each of the CPUs 301 and 501 may be not only a single CPU but also a plurality of CPUS.

(6) A neural network may be used in at least one of the above calculations executed by the above relationship analysis unit 34. For example, the relationship analysis unit 34 uses a neural network that vectorizes words such as Word2Vec to analyze words representing human behaviors or regulations related to each of the detailed items.

### REFERENCE SIGNS LIST

1 Communication system
3 Strategic planning support device
5 Communication terminal
31 Input reception unit (one example of input reception means)
32 Similar event retrieval unit (one example of similar event retrieval means)
33 Financial analysis unit (one example of financial analysis means)
34 Relationship analysis unit (one example of relationship analysis means)
35 Output unit (one example of output means)
41 Event DB
42 Ontology DB
43 Financial information DB

1. A strategic planning support device comprising:
a processor; and
a memory storing program instructions that cause the processor to:
analyze a word representing human behavior or regulations related to each of a plurality of detailed items in a financial index of a predetermined organization, the financial index varying due to a past similar event similar to an event of the predetermined organization; and
output, as each element of a coordinate axis of a driving force, a first word representing human behavior related to a first detailed item having the largest ratio in the financial index and a second word representing human behavior related to a second detailed item in which an absolute value of a correlation coefficient related to a correlation with the human behavior or regulations related to the first detailed item is equal to or less than a threshold value, among the plurality of detailed items.

2. The strategic planning support device according to claim 1, wherein the program instructions cause the processor to:
refer to financial statements of the predetermined organization or other organizations of the same type as that of the predetermined organization in a predetermined period before and after a time when a past similar event similar to the event of the predetermined organization occurs, identify the financial index of a predetermined sector in the predetermined organization, the financial index varying due to the past similar event, and analyze the plurality of detailed items that is a breakdown of the financial index, and
analyze a word representing human behavior or regulations related to each of the plurality of detailed items.

3. The strategic planning support device according to claim 2, wherein the program instructions cause the processor to:
retrieve the past similar event based on the data of the event of the predetermined organization using the data indicating the past event and an ontology dictionary,
refer to financial statements of the predetermined organization or other organizations of the same type as that of the predetermined organization in a predetermined period before and after a time when the past similar event occurs,
identify the financial index of a predetermined sector in the predetermined organization, the financial index varying due to the past similar event, and
analyze the plurality of detailed items that is a breakdown of the financial index.

4. The strategic planning support device according to claim 3, wherein the program instructions cause the processor to:
receive an input of data of an event of the predetermined organization, and
retrieve a past similar event based on the data of the event of the predetermined organization using the data indicating the past event and the ontology dictionary.

5. The strategic planning support device according to claim 1, wherein the program instructions cause the processor to analyze a word having a similarity close to each of the detailed items and representing human behavior or regulations by natural language processing of vectorizing the word.

6. The strategic planning support device according to claim 1, wherein the program instructions cause the processor to analyze a word representing human behavior or regulations related to each of the detailed items using a neural network.

7. A strategic planning support method comprising:
analyzing a word representing human behavior or regulations related to each of a plurality of detailed items in a financial index of a predetermined organization, the financial index varying due to a past similar event similar to an event of the predetermined organization, and
outputting, as each element of a coordinate axis of a driving force, a first word representing human behavior related to a first detailed item having the largest ratio in the financial index and a second word representing human behavior related to a second detailed item in which an absolute value of a correlation coefficient related to a correlation with the human behavior or regulations related to the first detailed item is equal to or less than a threshold value, among the plurality of detailed items.

8. A non-transitory computer-readable recording medium having stored therein a program for causing a computer to execute the method according to claim 7.
